(19) United States
(12) Patent Application Publication
(10) Pub. No.: US 2015/0208743 A1
(43) Pub. Date: Jul. 30, 2015

(54) Polylactic Acid Gloves and Methods of Manufacturing Same

(71) Applicants: Curtis P. Hamann, Paradise Valley, AZ (US); Sebastian S. Plamthottam, Upland, CA (US)

(72) Inventors: Curtis P. Hamann, Paradise Valley, AZ (US); Sebastian S. Plamthottam, Upland, CA (US)

(21) Appl. No.: 14/679,611

(22) Filed: Apr. 6, 2015

Related U.S. Application Data
(62) Division of application No. 12/820,580, filed on Jun. 22, 2010.
Application No. 12/820,580 is a continuation-in-part of application No. 11/680,041, filed on Feb. 28, 2007, now abandoned.
(60) Provisional application No. 60/777,883, filed on Mar. 1, 2006.

(51) Int. Cl. A41D 31/00; C08K 5/1535; A41D 19/00; C08K 5/092

(52) U.S. Cl. CPC A41D 31/0011; C08K 5/092; C08K 5/1535; A41D 19/0055; A41D 2400/52; A41D 2500/50

(57) ABSTRACT

Biodegradable disposable gloves and methods of manufacturing the same are disclosed in which the elastomeric material used to manufacture the gloves includes a polylactic acid polymer component in combination with a biodegradable plasticizer.

### CROSS-REFERENCE TO RELATED PATENT APPLICATIONS

This patent application is a Division of and claims priority to and the benefit of co-pending U.S. patent application Ser. No. 12/820,580 filed Jun. 22, 2010 which is a Continuation-in-Part of U.S. patent application Ser. No. 11/680,041, filed Feb. 28, 2007, which claimed the benefit of U.S. Provisional Patent Application No. 60/777,883, filed Mar. 1, 2006, the entire teachings and disclosure of which are incorporated herein by reference thereto.

### FIELD OF THE INVENTION

The present invention relates generally to disposable gloves. More particularly, the present invention relates to biodegradable disposable gloves constructed of polylactic acid and methods of making the same.

### BACKGROUND OF THE INVENTION

Disposable gloves are widely used by members of the medical community, the scientific community, and the industrial community to protect the wearer from chemical exposure, mechanical abrasion, environmental hazards, and biohazard contamination, and to prevent transmission of disease or contaminants. Health care providers frequently wear disposable gloves while performing surgery or other medical or dental procedures such as patient examinations; thus, the gloves are often also referred to as disposable examination gloves or disposable surgical gloves. The disposable gloves are impermeable to biological fluids, tissues, and solids produced by the body or other contaminants (human or animal), advantageously protecting the wearer from fomitic (transmission by objects that harbor pathogenic organisms) transmission of pathogens and disease.

Also, disposable gloves are worn by individuals who wish to protect their hands from various chemicals, materials, and objects which may irritate, damage or dry out the user's skin and which may be harmful or potentially harmful if allowed to contact or permeate the dermal barrier. These gloves may be worn in the occupational setting by scientists, cleaning service workers, food handlers, law enforcement workers, beauticians or other workers having special protection needs. Thus, disposable gloves may also be referred to as protective gloves, food handling gloves or industrial gloves.

As is known in the art, disposable gloves are thin and flexible and are typically manufactured from a variety of polymeric materials/resins herein throughout referred to as “elastomer(s)” or “elastomeric material(s)” or “elastomeric blend(s)”.

The types of elastomers typically utilized in the manufacture of disposable gloves include materials such as synthetic rubber or plastic. Examples of such materials can include, but are not limited to, synthetic polyisoprene, a chloroprene (including Neoprene-homopolymer of the conjugated diene chloroprene), a polyurethane (“PU”), a polyvinyl chloride (“PVC”), a styrene butadiene styrene (“SBS”), a styrene isoprene styrene (“SIS”), a silicone, a butadiene methylmethacrylate, an acrylonitrile, a styrene ethylene butylene styrene (“SEBS”), and/or acrylate-based hydrogels. Regardless of the type of end use application and/or specific thermoplastic used, elastomeric gloves are typically thrown away after a single use, and therefore, a significant amount of waste is generated.

Importantly, many of the polymers utilized in manufacturing disposable gloves are petroleum based and resist environmental degradation. Indeed, the environmental impact of nonbiodegradable plastic waste is a growing concern and alternative disposal methods for such plastics are limited. For example, incineration of synthetic plastics generates toxic emissions and satisfactory landfill sites are becoming increasing limited.

Further, petroleum resources are finite. Indeed, as petroleum reserves decrease in abundance, the raw material and production costs associated with the manufacture of such nonbiodegradable, thermoplastic gloves will increase accordingly. In addition, government regulations may increase disposal and recycling costs for nonbiodegradable plastics to accommodate landfilling and/or environmental impact resulting from use of such materials.

Fully biodegradable polymers have been commercially available for a number of years. Among these polymers, polylactic acid has been extensively studied in medical implants, suture, and drug delivery systems due to its biodegradability and has been approved for use in various medical devices. As is well known to those skilled in the art, polylactic acid polymers have physical properties that compare to petroleum-based synthetic polymers, rendering them useful over other biodegradable polymers.

Polylactic acid can be made from lactic acid (lactate). Lactic acid is a natural molecule that is widely employed in foods as a preservative and a flavoring agent. It is the main building block in the chemical synthesis of the polylactide family of polymers. Although it can be synthesized chemically, lactic acid is procured principally by microbial fermentation of sugars such as glucose or hexose. These sugar feed stocks can be derived from potato skins, corn, wheat, and dairy wastes. The lactic acid monomers produced by fermentation are then used to prepare polylactide polymers.

Lactic acid exists essentially in two stereoisomeric forms, which give rise to several morphologically distinct polymers: D-polylactic acid, L-polylactic acid, D,L-polylactic acid, meso-polylactic acids, and any combinations of thereof. D-polylactic acid and L-polylactic acid are stereoregular polymers. D,L-polylactic acid is a racemic polymer obtained from a mixture of D- and L-lactic acid, and meso-polylactic acid can be obtained from D,L-lactide. The polymers obtained from the optically active D and L monomers are semicrystalline materials, but the optically inactive D,L-polylactic acid is substantially amorphous.

Degradation of PLA occurs in two stages. First, the ester groups are gradually hydrolyzed by water to form lactic acid and other small molecules, and then these products are decomposed by microorganisms in the environment. In addition, disposal of PLA products is easier than that of traditional polymers, because polylactic acid incinerates cleanly with lower energy yield, thereby permitting a higher incinerator facility throughput. Further, PLA contains no chlorine or aromatic groups, so PLA burns much like paper, cellulose, and/or carbohydrates—generating few combustion by-products.

In addition, polylactic acid polymers can be manufactured from renewable resources, unlike conventional, synthetic petroleum-based polymers—since the lactate from which it is ultimately produced can be derived from the fermentation of agricultural by-products such as corn starch or other starch-rich, substances like maize, sugar or wheat.

Biodegradable disposable gloves are only very generally known in the art; however, none of the gloves heretofore known have been constructed of a polylactic acid polymer. In particular, PLA is more expensive than many petroleum-derived commodity plastics, and, as such, use of PLA for disposable medical and/or inductrial gloves is cost prohibitive—especially given the sheer number of disposable gloves utilized, for instance, in hospitals and clinics. Further, carcinogenicity and toxicity concerns related to the use of certain plasticizers have previously taught against use of PLA polymers in the production of disposable medical gloves.

U.S. Pat. No. 6,393,614 to Eichelbaum discloses a disposable, loose-fitting glove with pockets for carrying an item such as a tampon or sanitary napkin from a patient. While the glove is recited to be biodegradable in theory, no material of construction or degradability specifications are disclosed or suggested. Indeed, the '614 patent does not enable or provide a description of the biodegradable materials or methods of construction/manufacturing considered within the scope of the invention.

Accordingly, there is a need for disposable gloves constructed of a biodegradable elastomeric material, as an alternative to conventional, nonbiodegradable glove materials—to reduce the amount of waste associated with use of disposable gloves and/or to reduce the dependency on petroleum based gloves. In particular, there is a need for biodegradable gloves that meet the durability requirements, industry guidelines, and/or federal food and drug safety requirements associated with their intended end-use applications. It is a further objective of the present invention to provide biodegradable gloves that have the feel, stretch, and sensitivity of conventional, nonbiodegradable thermoplastic gloves.

Accordingly, it is a primary objective of the present invention to provide biodegradable, disposable gloves manufactured of a polylactide polymer. It is a related objective of the present invention to provide disposable gloves for use in a wide variety of applications, including but not limited to healthcare, food handling, cosmetic, biomedical, electrical, and/or cleanroom applications, wherein the disposable gloves are constructed of polylactic acid alone or in combination with other biodegradable elastomeric materials. The resulting glove being at least partially biodegradable and/or meeting the biodegradability requirements established by a particular industry, government authority, and/or environmental agency.

In addition, while disposable gloves can also be manufactured of natural latex rubber, which may be at least in part biodegradable, issues with latex allergies is a significant issue for some users; rendering the need for a non-latex, biodegradable disposable gloves essential in the art.

Accordingly, it is a further objective of the present invention to provide disposable gloves manufactured from polylactic acid and/or a polymeric blend including a polylactic acid component—the amount of polylactic acid component within the elastomeric matrix of the glove varying depending upon desired performance properties or end-use application, including such factors as the particular chemical permeability and/or sensitivity properties required by the application, the environmental stability required and/or required degradation rate required (i.e. oxidative stability, ozone, UV, temperature, and humidity) and/or the physical properties (tear and/or puncture strength) required. In particular, the polylactide gloves of the present invention can be constructed to meet relevant ASTM Standards for biodegradability and/or compostability.

A preferred polylactide disposable glove constructed in accordance with the present invention can be manufactured without requiring substantial modification to existing manufacturing methods for such articles. Also, the polylactide, disposable gloves of the present invention should retain all of the desirable functional characteristics of disposable gloves constructed of conventional, nonbiodegradable elastomeric materials.

### BRIEF SUMMARY OF THE INVENTION

The disadvantages and limitations of the background art discussed above are overcome by the present invention. With this invention, biodegradable disposable gloves constructed of polylactide and methods for making the same are disclosed. The present invention includes gloves for use in a wide number of medical and/or industrial applications and is not limited to any one particular application.

For the purposes of the present application, the term “biodegradable” and/or “biodegradability” refers to a degradable plastic in which degradation results from the action of naturally occurring microorganisms such as bacteria, fungi, and/or algae. “Degradation” refers to an irreversible process leading to a significant change of the structure of a material, typically characterized by a loss of properties (e.g. integrity, molecular weight, structure or mechanical strength) and/or fragmentation. Degradation can be affected by environmental conditions, such as exposure to ozone, ultraviolet light, extreme temperatures, and/or humidity, and proceeds over a period of time.

Accordingly, the biodegradable gloves of the present invention can be designed to comply with any biodegradability and/or compostability standards/requirements established by a particular government agency and/or industry, such as, for example, relevant ASTM or ISO standards. As such, the present invention is not limited to any one specific biodegradability standard and/or degradation rate for biodegradability—and is a matter of design choice. Indeed, the present invention can include gloves designed to degrade at certain degradation rate required by a given standard or regulation and/or gloves that merely degrade at a rate faster than a conventional non biodegradable glove.

Accordingly, in part, the biodegradable gloves of the present invention can be constructed of one or more layers of an elastomeric material including a polylactic acid polymer component. The polylactic acid polymer component preferably comprises from about 1% to about 100% L-lactide monomer, with the remaining monomer selected from, but not limited to, D-lactide, meso D,L lactide, D,L lactide monomers, and combinations thereof.

However, consistent with the broader aspects of the present invention, the polylactic acid polymer component can be any homopolymer of lactic acid and/or a block, graft, random, and/or copolymer of lactic acid, including, D-polylactic acid, L-polylactic acid, D,L-polylactic acid, meso-polylactic acid, and any combination of D-polylactic acid, L-polylactic acid, D,L-polylactic acid, and meso-polylactic acid, depending on the given end-use application of the gloves and/or the specified/required rate of biodegradability.

The disposable gloves of the present invention further includes one or more biodegradable plasticizer. The biodegradable plasticizer is provided within the polylactide elastomeric matrix used to construct the one or more of the layers of the biodegradable glove. Such plasticizer components preferably include, but are not limited to, citric acid esters, such as, triethyl citrate, acetyl triethyl citrate, and/or acetyl tributyl citrate. Where required, the disposable gloves of the present invention can include additional plasticizers capable of plasticizing PLA (e.g. nontoxic, nonbiodegradable, and/or only substantially biodegradable plasticizers may be used.)

As is well known to those skilled in the art, plasticizers are compounds that are incorporated into disposable materials of the present invention during, or after, polymerization. Introduction of plasticizers into the polylactide polymer can reduce the melt viscosity of the polymer and lower the temperature, pressure, and shear rate required to form the polymer. Plasticizers introduce pliability, flexibility, and toughness into a polymer to an extent not typically found in a material containing only a polymer or copolymer—as such, plasticizers can also affect the degradation rate of the glove.

Accordingly, the polylactic acid polymer, the ratio and/or types of lactide monomers utilized therein, and the biodegradable plasticizer are provided in a quantity sufficient to maintain or to not fall outside the physical requirements of the ASTM and ISO standards for the particular type of glove manufactured (such as, but not limited to all physical requirement tables, ASTM D 3577-01a^{•2}—Table 3, ASTM D 5250-00^{•4}—Table 3, ASTM D 6319-00a^{•3}—Table 3, ISO 11193:1994(E)—Table 3, ISO 10282: 1994(E)—Table 3, ASTM D 3578-01a^{•2}—Table 1, and ASTM D 4679-02—Table 3).

In certain other preferred embodiments, the biodegradable gloves of the present invention can be constructed of more than one layer of elastomeric material including a polylactic acid polymer and a biodegradable plasticizer, with each layer of the glove being designed to comply with specific requirements for a given end-use application—wherein each layer is designed to have substantially similar or substantially different physical properties (permeability, tear strength, and/or puncture strength), degradation rates, and/or environmental sensitivity properties (i.e. oxidative stability, ozone, UV, temperature, and humidity).

Further, one or more of the layers of the polylactic acid glove of the present invention can include additional components/additives incorporated into the elastomeric material from which the glove is made and/or have additional components coated on one or more surfaces of the glove. For example, a flavoring component, a therapeutic component and/or a botanical component may be included in the elastomeric material from which the glove is made.

Further, in certain other embodiments, the present invention includes a biodegradable, disposable constructed of a biodegradable polymer component comprising substantially a polylactic acid resin in combination with one or more other biodegradable materials/resins, including but not limited to starch or an aliphatic polyester.

It may therefore be seen that the present invention provides a fully and/or substantially biodegradable disposable glove to reduce the amount of waste associated with use of disposable gloves and/or to reduce the dependency on petroleum based gloves. In particular, the present invention provides biodegradable gloves that meet the durability requirements and/or industry guidelines associated with a particular end-use application, having the feel, stretch, and sensitivity of conventional, nonbiodegradable thermoplastic gloves.

Thus, it may also be seen that the present invention provides a biodegradable, polylactide-based disposable glove for use in a wide variety of applications, including but not limited to healthcare, food handling, cosmetic, biomedical, electrical, and/or cleanroom applications, wherein the disposable gloves are constructed of polylactic acid alone or in combination with other biodegradable elastomeric materials.

Thus, it may also be seen that the present invention provides a method for manufacturing biodegradable, polylactide-based disposable gloves including providing a polylactic acid based elastomeric matrix and forming a disposable glove from the polylactic acid based elastomeric material.

In one embodiment, a glove including at least one elastomeric layer, which comprises a polylactic acid polymer component and a biodegradable plasticizer component, is provided. The glove has a thickness between about 0.01 mm and 2 mm, a tensile strength of at least 10 MPa, and an elongation above about 200%. In another embodiment the glove has a thickness between about 0.05 mm and about 0.2 mm, a tensile strength between about 10 MPa and 25 MPa, an elongation between about 250% and 450%, and a modulus at 100% elongation of about between 1 MPa and 4 MPa. Preferably, the glove is formed from a polylactic acid polymer plastisol or a polylactic acid polymer organosol.

The polylactic acid polymer component of the elastomeric layer of the glove comprises D polylactic acid, L polylactic acid, D,L polylactic acid, meso polylactic acid, and any combination of D polylactic acid, L polylactic acid, D,L polylactic acid, and meso polylactic acid. The biodegradable plasticizer component is selected from a group consisting of polyethylene glycol, polypropylene glycol, sorbitol derivatives such as isosorbide diesters, glucose monoesters, citric acid esters, epoxidised oils, lactide monomers, octyl phenol ethoxylates. Preferably, the biodegradable plasticizer is an isosorbide diester.

In some embodiments, the polylactic acid polymer component of the glove comprises between about 50 wt. % and 80 wt. %, and the biodegradable plasticizer component comprises between about 20 wt. % and 40 wt. %. Optionally, the at least one elastomeric layer of the glove can include a non-ionic surfactant.

In one embodiment, the at least one elastomeric layer of the glove further comprises a biodegradable polymer resin selected from the group consisting of homopolymers, block, graft, random, copolymer and polyblends of polyglycolic acid, polycaprolactone, polyhydroxybutyrate, aliphatic polyesters, polyalkylene esters, polyester amides, polyvinyl esters, polyester carbonates, polyvinyl alcohols, polyanhydrides, polysaccharides, and combinations thereof. Further the glove can also include at least one of a flavoring component, an antimicrobial agent, a detackifying agent, a botanical extract, a donning enhancing agent, a colorant component, and a therapeutic component incorporated into one or more of the at least one elastomeric layer.

In another embodiment, a method of forming a thin article is provided. The method includes steps of dispersing a polylactic acid polymer powder in a plasticizer to form a PLA dispersion and forming a thin article using the dispersion. The method further includes a step of preparing the polylatic acid polymer powder having an average particle size below about 100 micron.

In such embodiment, the step of dispersing involves selecting the plasticizer compatible with the polylactic acid polymer, mixing the plasticizer and the polylactic acid polymer powder to form a PLA plastisol, and controlling a viscosity of the PLA plastisol for a dip forming process. In one embodiment, the PLA plastisol is formed by mixing the polylactic acid polymer powder between about 50 wt. % and 80 wt. %, and the plasticizer component comprises between about 20 wt. % and 40 wt. %. The PLA plastisol can also include a non-ionic surfactant in some embodiments. One way of controlling the viscosity to obtain a viscosity suitable for dip forming process is by adding a diluent, thereby forming a PLA organosol. The viscosity of the PLA organosol can be further controlled by adding a dispersant.

In some embodiment, the step of forming includes dip forming a glove from the PLA dispersion, wherein a glove former is dipped in the PLA dispersion and heated to fuse the polylactic acid polymer to form a glove including at least one polylactic acid polymer elastomeric layer.

In another embodiment, a polylactic acid polymer dispersion for forming a thin article is provided. Preferably, the thin article is an elastomeric glove. The dispersion comprises a polylactic acid polymer powder dispersed in a plasticizer, which is compatible with the polylactic acid polymer. In one embodiment, the dispersion is a plastisol having a viscosity suitable for a dip forming process. The plastisol includes the polylactic acid polymer powder between about 50 wt. % and 80 wt. %, and the plasticizer between about 20 wt. % and 40 wt. %. Optionally, a non-ionic surfactant can be added in the plastisol. Further, a dispersant can be added to obtain a viscosity suitable for dip forming, thereby forming an organosol.

Preferably, the plasticizer is a biodegradable plasticizer. The biodegradable plasticizer is selected from a group consisting of polyethylene glycol, polypropylene glycol, sorbitol derivatives such as isosorbide diesters, glucose monoesters, citric acid esters, epoxidised oils, lactide monomers, octyl phenol ethoxylates.

Other advantages and features of the invention, together with the organization and manner of operation thereof, will become apparent from the following detailed description when taken in conjunction with the accompanying drawings. It is expressly understood that the drawings are for the purpose of illustration and description only, and are not intended as a definition of the limits of the invention.

The biodegradable gloves of the present invention are of a construction which is both durable and long lasting, and which will require little or no maintenance to be provided by the user throughout its operating lifetime. The biodegradable gloves of the present invention are also of inexpensive construction to enhance their market appeal and to thereby afford them the broadest possible market. Finally, all of the aforesaid advantages and objectives are achieved without incurring any substantial relative disadvantage.

### BRIEF DESCRIPTION OF THE DRAWINGS

These and other advantages of the present invention are best understood with reference to the drawings, in which:

FIG. 1 is a perspective view of a glove showing an outer surface thereof and an inner or wearer-contacting surface thereof;

FIG. 2 is a cross sectional view of a portion of a single layer glove constructed of a polylactide polymer;

FIG. 3 is a cross sectional view of a portion of a bilaminar layer glove having two layers constructed of a polylactide polymer;

FIG. 4 is a cross sectional view of a portion of a single layer glove constructed of a biodegradable polymer including at least in part a polylactide polymer component;

FIG. 5 is a schematic flow diagram showing a dipping process for making a glove of the present invention;

FIG. 6 is a schematic flow diagram showing a method of making a glove of the present invention;

FIG. 7 is a flow diagram of a method of dip forming a PLA glove using a PLA plastisol according to an embodiment of the present invention; and

FIG. 8 is a flow diagram of a method of dip forming a PLA glove using a PLA organosol according to an embodiment of the present invention.

### DETAILED DESCRIPTION OF THE INVENTION

This invention relates to biodegradable disposable gloves constructed at least in part of a polylactic acid polymer material and methods for making the same. As will be readily appreciated by those skilled in the art, other dipped elastomeric articles, such as condoms, may be included within the broader aspects of the present invention.

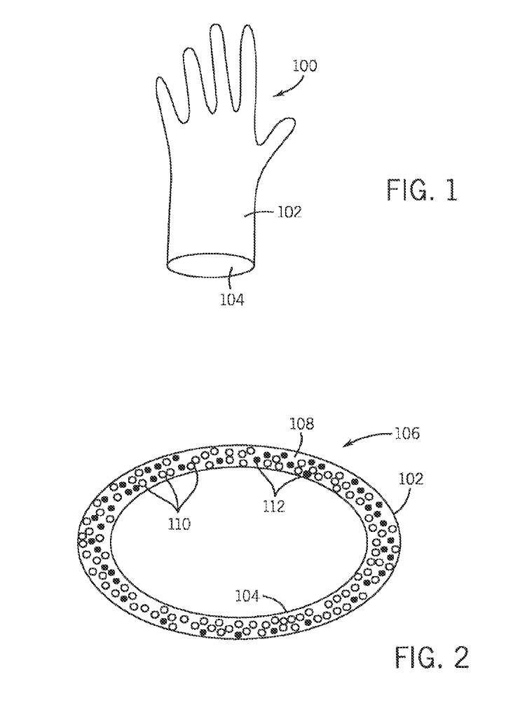

An exemplary elastomeric article, a glove 100, in accordance with the present invention, is illustrated in FIG. 1. The glove 100 includes an outside surface (distal surface or outer distal surface or outermost surface) (“OS”) 102 and an inside or wearer-contacting surface (“WCS”) 104. It will be appreciated by those skilled in the art, for purposes of the following discussion, the glove 100 may be a single layer glove, a bilaminar glove (two layers), and/or a multilayer glove wherein the exterior appearance of the glove 100 is substantially similar to that shown in FIG. 1, having an outside surface 102 and wearer-contacting surface 104.

Turning next to FIG. 2, a cross section of a glove 106 constructed of a single layer 108 of elastomeric material is illustrated. (It will be appreciated that the single layer glove 106 has an exterior appearance similar to glove 100 and has an outside surface 102 and a wearer-contacting surface 104).

The elastomeric material used to construct the layer 108 of the glove 106 comprises a polylactic acid polymer component 110 and a plasticizer component 112. In particular, the layer 108 of elastomeric material used in the glove 106 includes from about 1% to about 100% polylactic acid polymer component 110 and from 1% to about 100% plasticizer component 112. In one embodiment, the layer 108 of elastomeric material used in the glove 106 includes from about 1% to about 80% polylactic acid polymer component 110 and from 1% to about 20% plasticizer component 112.

The polylactic acid polymer component 110 preferably comprises from about 1% to about 100% L-lactide monomer, with the remaining monomer selected from, but not limited to, D-lactide, meso D,L lactide, D,L lactide monomers, and combinations thereof. Consistent with the broader aspects of the present invention, the polylactic acid polymer component 110 can be any homopolymer of lactic acid and/or a block, graft, random, copolymer, and/or a polyblend/elastomeric blend of lactic acid, including, D-polylactic acid, L-polylactic acid, D,L-polylactic acid, meso-polylactic acid, and any combination of D-polylactic acid, L-polylactic acid, D,L-polylactic acid, and meso-polylactic acid. Suitable polylactide polymers can include, but are not limited to, those sold under the registered trademark NatureWorks from Cargill Dow or its licensees.

In particular, the particular weight percent of L-lactide, D-lactide, meso D,L Lactide, and/or D,L lactide monomer utilized in the glove 106 of the present invention can depend on the given end-use application of the gloves, e.g. the physical and/or permeability requirements of the gloves, the amount and/or type of plasticizer utilized and/or a specified degradation rate required for the gloves after disposal.

Indeed, as will be appreciated by those skilled in the art, a higher concentration of D-lactide monomer included within the polylactic acid polymer component 110 can result in a polymer of greater crystallinity, yielding a higher tensile strength and lowering the elongation modulus of the final glove. As such, the concentration of a particular lactide monomer can be varied, as a matter of design choice, depending on the desired physical, chemical and/or degradation properties required for the glove application.

Without limitation, the biodegradable gloves of the present invention may be designed to have performance properties that meet or exceed those required for a petroleum based glove of similar use or function. For example, the gloves of the present invention preferably have a minimum film thickness of about 0.05 mm, a tensile strength of about 10 MPa, and an elongation at break of about 300% (reference is made to ASTM Standard D 5250-00^{•4}.

The polylactic acid polymer component 110, and the ratio and/or types of lactide monomers utilized therein, are provided in a quantity sufficient to maintain or to not fall outside the physical requirements of the ASTM and ISO standards for the particular type of glove manufactured (such as, but not limited to all physical requirement tables, ASTM D 3577-01a^{•2}—Table 3, ASTM D 5250-00^{•4}—Table 3, ASTM D 6319-00a^{•3}—Table 3, ISO 11193:1994(E)—Table 3, ISO 10282: 1994(E)—Table 3, ASTM D 3578-01a^{•2}—Table 1, and ASTM D 4679-02—Table 3).

The plasticizer component 112 provided within the elastomeric material used to construct the layer 108 of the glove 106 can be any biodegradable plasticizer known to those skilled in the art capable of plasticizing the polylactic acid polymer component 110. Such plasticizer components 112 preferably include, but are not limited to, citric acid esters, such as, triethyl citrate, acetyl triethyl citrate, and/or acetyl tributyl citrate.

Other biodegradable plasticizers may be used with good effect. Such plasticizers can include either substantially hydrophobic and/or substantially hydrophilic plasticizers, depending on the particular composition of the elastomer material, and include, but are not limited to, starch (corn, wheat, rice, potato, etc.), vegetable oils (soybean, linseed, etc.), sorbitol, glycerol, glycerin, glucose or sucrose ethers and esters, polyethylene glycol ethers and esters, low toxicity phthalates, alkyl phosphate esters, dialkylether diesters, tricarboxylic esters, epoxidized oils, epoxidized esters, polyesters, polyglycol diesters, alkyl, allyl ether diesters, aliphatic diesters, alkylether monoesters, dicarboxylic esters, and/or combinations thereof.

Further, plasticizers, in certain applications, can be selected to comply with the required industry, regulatory, and/or governmental standards, for example, those approved by the Food and Drug Administration for use in medical and/or examination gloves—as will be well known to those skilled in the art.

The plasticizer component 112 can be incorporated into the layer 108 of the glove 106 during, or after, polymerization of the polymer component. The plasticizer component 112 is provided in an amount sufficient to impart the desired physical requirements to the polylactic acid polymer component 110 and/or to increase or decrease the polymer degradation rate. As such, addition of the plasticizer component 112 to the polylactic acid polymer component 110 can also be used to control the operative degradation rate of the disposable gloves of the present invention.

In light of the foregoing, it will be readily appreciated by those skilled in the art that the elastomeric material including the biodegradable polylactide polymer component 110 and the plasticizer component 112 used in the glove 106 can be prepared as a compounded elastomer and may be an elastomer suspended into an emulsion, or an elastomer that is soluble or miscible in a solvent or plasticizer, and combinations thereof.

Further, consistent with the broader aspects of the present invention, the layer 108 may include additional components: 1) incorporated into the elastomeric material (including the polylactic acid polymer component 110) from which the glove is made; and/or 2) coated on one or more surfaces of the glove 106. For example, a flavoring component, a detackifying agent, a donning enhancing agent, and/or a botanical component may be included in the elastomeric material from which the glove is made. For example, xylitol as described in more detail in U.S. patent application Ser. No. 11/138,193 entitled “Flavored Elastomeric Articles and Methods of Manufacturing Same”; Aloe extract and/or Nopal extract as described in more detail in U.S. patent application Ser. Nos. 10/373,970 and 10/373,985, entitled “Flexible Elastomer Articles and Methods of Manufacturing,” and in U.S. patent application Ser. No. 10/640,192, entitled “Gloves containing dry powdered aloe and method of manufacturing,” (each of which is assigned to the assignee of the present patent application and each of which is hereby incorporated herein by reference) may be included within the elastomeric matrix of the glove.

In addition, the layer 108 of the glove 106 may include one or more therapeutic components having one or more of the qualities of wound healing, anti-inflammatory properties, anti-microbial properties, analgesic properties, and anti-aging properties, as will also be appreciated by those skilled in the art. In addition, the layer 108 of the glove 106 may be colored and/or include a colorant within the elastomeric matrix from which it is formed. Such components are selected to be compatible with the polylactic acid polymer component 110 and/or plasticizer component 112 and are provided in a quantity sufficient such that the glove 106 maintains or does not fall outside the ASTM and/or ISO standards required for the particular type of glove manufactured, as will also be well known to those skilled in the art.

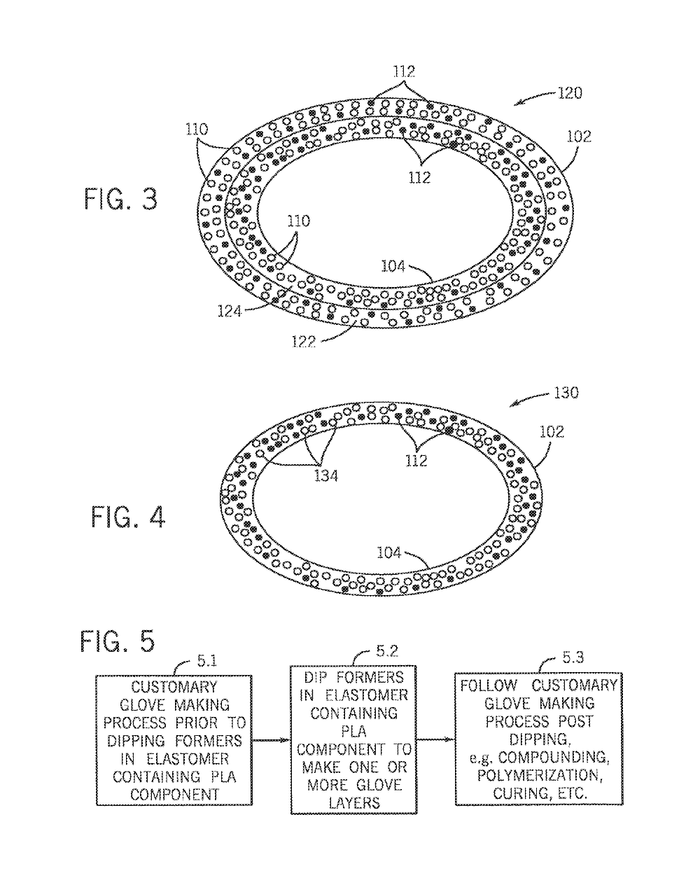

Referring next to FIG. 3, a cross section of a bilaminar glove 120 having a first layer 122 and a second layer 124 is shown. First layer 122 forms an exterior layer of the glove 120 and has an outside surface 102. The second layer 124 forms an interior layer of glove 120, having a wearer-contacting surface 104. It will be appreciated that the glove 120 has an exterior appearance similar to glove 100 (shown in FIG. 1).

The elastomeric material used for each of the first layer 122 and the second layer 124 of the bilaminar glove 120 comprises a polylactic acid polymer component 110 and a plasticizer component 112. In particular, each of the layers 122 and 124 of elastomeric material used in the glove 120 includes from about 1% to about 100% polylactic acid polymer component 110 and from about 1% to about 100% plasticizer component 112.

The polylactic acid polymer component 110 can be any homopolymer of lactic acid and/or a block, graft, random, copolymer, and/or polyblend of lactic acid, including, D-polylactic acid, L-polylactic acid, D,L-polylactic acid, meso-polylactic acid, and any combination of D-polylactic acid, L-polylactic acid, D,L-polylactic acid, and meso-polylactic acid.

As recited with reference to the glove 106, the particular weight percent of D-lactide, L-lactide, meso D,L Lactide, and/or racemic D,L lactide monomer in each of the layers 122 and 124 can depend on the given end-use application of the gloves, e.g. the physical and/or permeability requirements of the gloves and/or the respective layers 122 and 124, the amount and/or type of plasticizer utilized within each of the layers 122 and 124, and/or a specified degradation rate required for the gloves after disposal.

The first layer 122 and the second layer 124 of the glove 120 may be made of a similar or a dissimilar polylactic acid-based elastomeric materials, including each layer comprising a different combination and/or weight percent of D-lactide, L-lactide, meso D,L Lactide, and/or racemic D,L lactide monomer within the polylactic acid polymer component 110 in each of the layers 122 and 124.

The plasticizer component 112 utilized within each of the layers 122 and 124 of the glove 120 is preferably a biodegradable plasticizer and includes any of those recited herein with respect to the glove 106. Accordingly, the plasticizer component 112 is preferably a citric acid ester, such as, triethyl citrate, acetyl triethyl citrate, and/or acetyl tributyl citrate.

The plasticizer component 112 can be incorporated into each of the layers 122 and 124 of the glove 120 during, or after, polymerization of the polymer component. As described with reference with the glove 106, the plasticizer component 112 is provided in an amount sufficient to impart the desired physical requirements to the polylactic acid polymer component 110 and/or to increase or decrease the polymer degradation rate. Accordingly, addition of the plasticizer component 112 to the polylactic acid polymer component 110 can also be used to control the operative degradation rate of the disposable gloves of the present invention—with such properties designed to be substantially similar in each of the layers 122 and 124, or each of the layers 122 and 124 of the glove 120 may be designed to have different properties. As such, the specific type of plasticizer component 112 used in each of the layers 122 or 124 may be similar or different, depending on the required properties of the glove 120.

As will be readily recognized by those skilled in the art, the gloves of the present invention can be constructed of any number of layers comprising one or more polylactic acid polymer components and one or more biodegradable plasticizer components. In particular, the present invention encompasses gloves constructed of two or more layers of elastomeric material including about 1% to about 100% polylactic acid polymer component and from 1% to about 100% biodegradable plasticizer component.

Accordingly, the polylactic acid polymer component 110 used in each of the one or more layers of the gloves of the present invention may be made of similar or dissimilar elastomeric materials, including each layer having a different combination and/or weight percent of D-lactide, L-lactide, meso D,L Lactide, and/or D,L lactide monomer. Further, the biodegradable plasticizer component 112 can include any of those recited herein with respect to the gloves 106 and 120. As such, the plasticizer component 112 used in each of the layers 122 or 124 may be similar or different, depending on the required properties of the glove 120.

Turning next to FIG. 4, and consistent with the broader aspects of the present invention, a cross section of a glove 130 constructed of a single layer 132 of elastomeric material is illustrated. (It will be appreciated that the single layer glove 130 has an exterior appearance similar to glove 100 and has an outside surface 102 and a wearer-contacting surface 104.)

Preferably, the layer 132 of elastomeric material in the glove 130 comprises a biodegradable polymer component 134 and a biodegradable plasticizer component 112. In particular, the layer 132 of elastomeric material used in the glove 130 includes from about 1% to about 100% biodegradable polymer component 134 and from about 1% to about 100% plasticizer component 112.

The biodegradable polymer component 134 is preferably a polylactic acid-based polymer comprising from about 1% to about 100% a homopolymer of lactic acid and/or from about 1% to about 100% a block, graft, random, copolymer, and/or polyblend of lactic acid, including, D-polylactic acid, L-polylactic acid, D,L-polylactic acid, meso-polylactic acid, and any combination of D-polylactic acid, L-polylactic acid, D,L-polylactic acid, and meso-polylactic acid.

The biodegradable polymer component 134 may further comprise any substantially biodegradable and/or compostable polymer component including, but not limited to, homopolymers, block, graft, random, copolymer, and/or polyblends of polyglycolic acid, polycaprolactone, polyhydroxybutyrate, aliphatic polyesters, polyalkylene esters, polyester amides, polyvinyl esters, polyester carbonates, polyvinyl alcohols, polyanhydrides, polysaccharides such as starch and combinations thereof, as will be well known to those skilled in the art.

In particular, the particular weight percent of polylactic acid-based polymer in the biodegradable polymer component 134 utilized in the glove 106 of the present invention can be depend on the given end-use application of the gloves, e.g. the physical and/or permeability requirements of the gloves, the amount and/or type of plasticizer utilized, and/or a specified degradation rate required for the gloves after disposal.

Preferably, the weight percent of the polylactic acid-based polymer is greater than about 75% of the biodegradable polymer component 134 and is provided in a quantity sufficient to maintain, and to not fall outside the physical requirements of the ASTM and ISO standards for the particular type of glove manufactured (such as, but not limited to all physical requirement tables, ASTM D 3577-01a^{•2}—Table 3, ASTM D 5250-00^{•4}—Table 3, ASTM D 6319-00a^{•3}—Table 3, ISO 11193:1994(E)—Table 3, ISO 10282: 1994(E)—Table 3, ASTM D 3578-01a^{•2}—Table 1, and ASTM D 4679-02—Table 3).

The plasticizer component 112 utilized in the glove 130 is preferably biodegradable and includes any one or more of those biodegradable plasticizers described herein or known to those skilled in the art capable of plasticizing the biodegradable polymer component 134. Such plasticizer components preferably include, but are not limited to, citric acid esters, such as, triethyl citrate, acetyl triethyl citrate, and/or acetyl tributyl citrate.

Consistent with the broader aspects of the present invention, and where required by a given end-use application for the glove or specified physical properties required for the glove, the layer 132 of elastomeric material in the glove 130 can comprise a nonbiodegradable and/or substantially nonbiodegradable polymer component, such as polyvinylchloride, in combination with the biodegradable polymer component 134 and the plasticizer component 112. Indeed, a polylactide polymer component and biodegradable plasticizer component can be used to modify or otherwise alter the degradation properties of a petroleum-based polymer—the resulting glove being substantially biodegradable compared to a glove manufactured of the petroleum-based polymer alone.

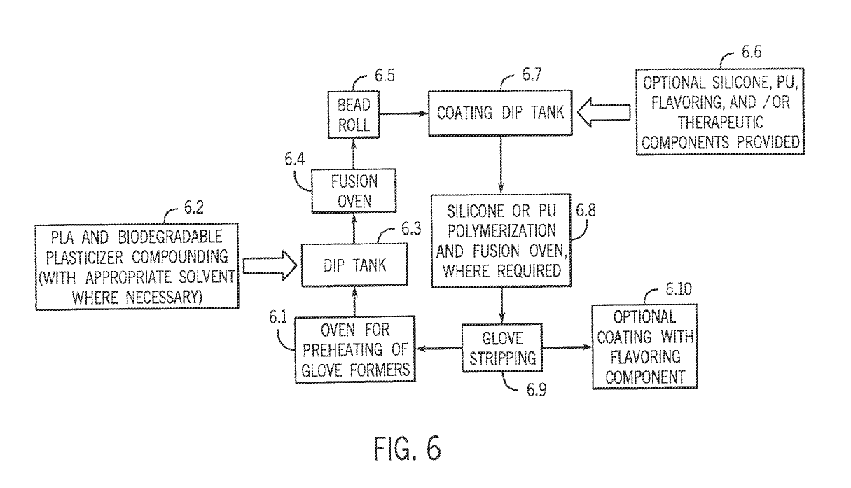

As best shown in FIG. 5, the present invention also comprehends the method of making a biodegradable, disposable glove having one or more layers constructed of a polylactic acid (PLA) polymer component and a biodegradable plasticizer component. As will be understood, the polylactic acid (PLA) polymer component and the biodegradable plasticizer component used in the methods described with reference to FIGS. 5 and 6 can be any one or more of those described with reference with the gloves 106, 120, and 130.

Turning next to FIG. 5, a general method of making the biodegradable, disposable gloves of the present invention is disclosed. In Step 5.1, the process of glove making of the present invention utilizes customary glove making procedures prior to dipping the formers into the elastomeric material containing the polylactic acid polymer component 110 and the plasticizer component 112. In Step 5.2, the formers are dipped into the elastomeric material including the polylactic acid polymer component 110 and the plasticizer component 112. The composition of the elastomeric material can be any of those disclosed herein.

In Step 5.3, the formers are processed according to usual glove making techniques, e.g. polymerization, compounding, curing, fusing, solvent evaporation, etc. to form a biodegradable, polylactic acid glove. The general process of FIG. 5, may be used for making single layer gloves, bilaminar gloves, and multilayer gloves.

As will be well known to those skilled in the art, the methods of making gloves of the present invention can utilize any general prior art glove making methods known to those skilled in the art—using an elastomeric material comprising a polylactic acid polymer. (see again, U.S. patent application Ser. Nos. 10/373,970 and 10/373,985, entitled “Flexible elastomer articles and methods of manufacturing”, and in U.S. patent application Ser. No. 10/640,192, entitled “Gloves Containing Dry Powdered Aloe and Method of Manufacturing”). Accordingly, the biodegradable, polylactic acid gloves of the present invention can be manufactured by any method known by those skilled in the art with merely a slight modification to existing processes.

For example, FIG. 6 discloses a dipping operation for manufacturing a biodegradable, polylactide glove of the present invention, wherein the elastomeric material of the glove includes one or more polylactic acid polymer components and one or more biodegradable plasticizer components of the type disclosed with reference to the gloves 106, 120 and/or 130 described herein.

In Step 6.1, an oven is prepared for pre-heating glove formers. In Step 6.2, the polylactic acid polymer component and the biodegradable plasticizer component are compounded (in the presence of an appropriate solvent, e.g. methylene chloride or tetrahydrofuran (THF), where required) and poured into a dip tank. Step 6.2 may also include the additional of optional components, such as colorants, as will be well known to those skilled in the art. In Step 6.3, the dip tank accepts the glove formers and the glove formers are coated with the elastomeric material including the polylactic acid polymer and the biodegradable plasticizer component. In Step 6.4, the glove formers, with the coating of the elastomeric material, enter a fusion oven. In Step 6.5, a bead roll cuff is applied to the fused elastomeric material.

In Step 6.6, optional silicone, polyurethane, flavoring, botanical, and/or therapeutic component can be provided. In Step 6.7, the glove formers are dipped into the dip tank containing such optional components. In Step 6.8, the silicone or polyurethane, where provided, are polymerized on the surface of the elastomeric material including the polylactic acid polymer and the biodegradable plasticizer component during fusion of the elastomeric material. After fusion, in Step 6.9 the biodegradable, polylactide gloves are stripped from the glove formers. Alternatively, in Step 6.10, the gloves are then optionally coated with one or more optional components such as a flavoring component, according to the previously discussed methods of coating gloves.

Accordingly, it will be readily apparent to those skilled in the art that the methods depicted in FIGS. 5 and 6 can also include incorporation of one or more colorants, flavoring, botanical, therapeutic, quality control/processing compositions into the elastomeric matrix containing the polylactic acid polymer component. It will also be readily apparent that the biodegradable, disposable polylactide gloves of the present invention may also be coated with one or more flavoring, botanical, therapeutic, quality control/processing compositions. Such coating materials can include, but are not limited to, xylitol, Aloe, Nopal, Vitamin E, Vitamin A, Vitamin C, Vitamin B₃, Vitamin B₅, jojoba, rose hip, tea tree oil, flax seed oil, palm oil, and/or acetylsalicylic acid.

In one embodiment, a glove is formed from a dispersion of a polylactic acid polymer (PLA) such as a plastisol or an organosol. The PLA plastisol or organosol can be used in dip forming or rotational casting type processes to form the PLA glove or other thin film articles such as condoms, catheters, etc. The PLA plastisol is prepared by dispersing PLA powder in plasticizer that is compatible with the PLA after fusion. Preferably, the plasticizer is biodegradable. The PLA plastisol can also include a surfactant or a surface active agent to control the viscosity and rheology of the dispersion.

When a PLA plastisol formulation includes less than about 35% by weight of plasticizer and has a high viscosity, a suitable diluent, and optionally a dispersant, is added to form a PLA organosol. The diluent is a weak solvent or nonsolvent for the PLA powder and the dispersant is a strong solvent for the PLA powder. A suitable diluent for a PLA organosol includes, but not limited to, isopropyl alcohol and epoxidized alcohol. In some embodiments, a single solvent, which combines both diluent and dispersion properties, such as certain long chain esters, ethers, alcohols, and the like, is used to form the PLA organosol. In such embodiments, longer alkyl chains provide weaker solvating properties for the PLA.

In PLA plastisols, PLA powder is not dissolved, but suspended in plasticizer. Similarly, in PLA organosols, PLA powder is not dissolved, but suspended in a liquid phase including plasticizer, diluent and optional dispersant. Such PLA plastisols and PLA organosols are more environmentally friendly and more economical when compared to a PLA solution, which includes a strong solvent for dissolving PLA powder. Further, it is difficult to find an environmentally friendly solvent for PLA, perhaps not available or cost prohibitive. Thus, processes like solvent casting that utilize a PLA solution are not suitable for forming PLA gloves and other PLA thin articles. Further, a PLA solution requires a much longer drying time than that of a PLA plastisol or a PLA organosol. There is virtually no drying step for the PLA plastisol and much shorter one for the PLA organosol, since the PLA powder is not dissolved in a diluent. Further, generally, the forming processes using a plastisol or organosol can reduce bubble formation when compared to solvent casting processes, thereby reducing defects in thin articles.

Further, the method of dip forming a glove or other thin film articles from a PLA plastisol or a PLA organosol according to embodiments of the present invention provides many advantages over conventional melt forming processes such as extrusion, blow molding, injection molding, spinning processes, etc. Such traditional melt forming processes cannot form thin elastomeric gloves and other thin film articles having complex shapes and sizes economically. Further, in forming processes using the PLA plastisol or PLA organosol, such as the dip forming process, PLA can fuse at a temperature much lower than the melting temperature of the PLA. This is because the PLA need not melt completely during fusion, but rather, need only flow to form a continuous film. Thus, the dip forming process using the PLA plastisol or PLA organosol can substantially reduce the heat exposure of the PLA, when compared to conventional melt forming processes that require complete melting of the PLA in high temperature and/or high shear conditions, such as extrusion and various molding processes. Since PLA is prone to rapid degradation under high temperature and humidity, the degradation of PLA can be substantially reduced by reducing or eliminating PLA exposure to high heat and shear.

Despite these advantages, PLA plastisols and PLA organosols were unknown in the industry. This is because of challenges in forming PLA plastisols and PLA organosols. Other non-biodegradable polymer plastisols have been known. For example, a polyvinyl chloride (PVC) plastisol have been used to form various thin articles. The PVC for forming PVC plastisol is made in an emulsion polymerization process, which forms particles having a substantially spherical shape and particle size of smaller than 0.2 micron to few microns. However, PLA is not made in emulsion, and thus, preparation of PLA powder for a PLA plastisol or PLA organosol involves a mechanical grinding, which results in a wider range of particle sizes and shapes. Such variation in particle size and shape makes the formation of a stable plastisol or organosol difficult. Further, plasticizers that can form a stable PLA plastisol and PLA organosol with such PLA powder were unknown in the prior art.

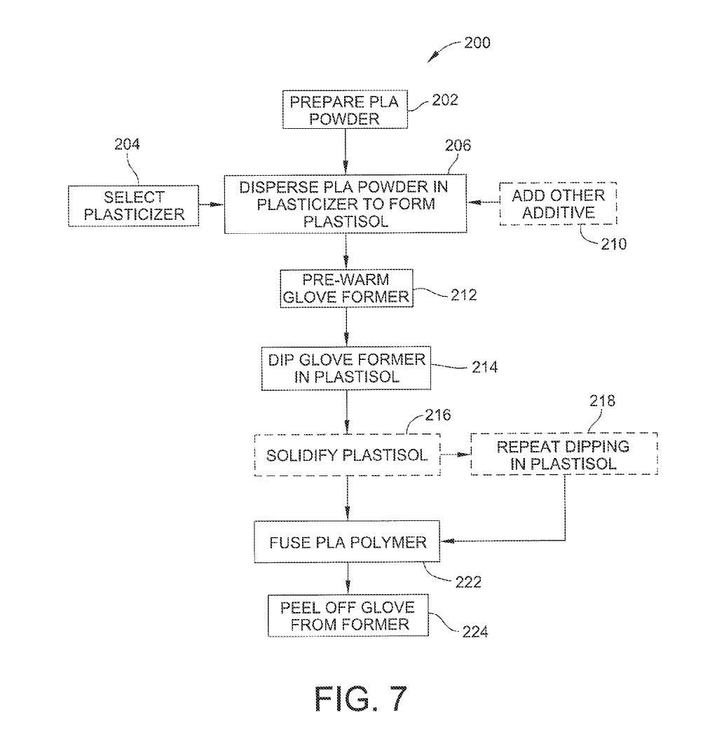

FIG. 7 is a flow chart illustrating a method of dip forming a PLA glove from a plastisol according to an embodiment of the present invention. The method 200 generally includes steps of preparing a PLA powder 202, selecting a plasticizer 204, dispersing the PLA powder in the plasticizer to form a plastisol 206, pre-warming a glove former 212, dipping the pre-warmed former in the plastisol 214, fusing the PLA polymer 222, and peeling off the PLA glove from the former 224. In some embodiments, the method 200 can include a step of solidifying the plastisol 216 and repeating dipping step 218 to form a multilayer glove.

The step of preparing PLA powder 202 can be carried out via various grinding or pulverizing techniques. In one embodiment, the PLA polymer is obtained in a form of pellets and ground into powder by cryogenic milling. In other embodiments, other suitable size reduction techniques such as ambient milling, jet milling, and/or micro grinding techniques can be used to prepare the PLA powder. Preferably, the PLA powder is ground at a temperature substantially below the glass transition temperature of the PLA polymer. The grinding technique can be selected according to the characteristics of the PLA polymer and a desired range of particle size. For example, a PLA polymer having a low glass transition temperature may require cryogenic milling. In one embodiment, the PLA powder has an average particle size below 1000 microns, preferably below 100 microns, more preferably below 25 microns. The PLA polymer can comprise polymers of lactic acid or lactide; the repeating unit can be L-lactide, D-lactide, or meso lactide, or R or S lactic acid and/or copolymers of D, L, or meso lactide monomers or R or S lactic acid monomers. The PLA polymer can be amorphous, crystalline or a mixture of both, depending on its polymeric structure. Example of such suitable PLA polymer for a PLA plastisol or a PLA organosol includes, but not limited to, Ingeograde PLA polymer pellets from NatureWorks LLC., and Ecorene PLA powders from ICO Polymers. Other preferred PLA polymers for a PLA plastisol or a PLA organosol include copolymers of PLA or blends with other biodegradable polymers.

A plasticizer that is compatible with the PLA polymer is selected in the step 204. A suitable plasticizer includes, but not limited to, sorbitol derivatives such as isosorbide diesters, alkyl phenol ethoxylates such as octyl phenol ethoxylates, glucose derivatives such as glucose monoesters, polyethylene glycol, polypropylene glycol, polyglycol derivatives such as polyglycol esters, fatty acid esters, citric acid esters such as acetyl tributyl citrate, triethyl citrate, acetyl triethyl citrate, lactide monomer, epoxidised oils such as epoxidsied soybean oil, epoxidised linseed oils, adipate esters, azealate esters, acetylated coconut oil, and the like.

Preferably, the selected plasticizer is biodegradable to minimize or eliminate non-biodegradable component to maximize the biodegradability of the PLA glove. Such biodegradable plasticizers include, but not limited to, polyethylene glycol, polypropylene glycol, sorbitol derivatives such as isosorbide diesters, glucose monoesters, citric acid esters, epoxidised oils, lactide monomers, octyl phenol ethoxylates and the like. In one embodiment, the selected plasticizer is compatible with the PLA during fusion and improves flexibility of the PLA glove. Further, the selected plasticizer minimizes or eliminates swelling or gelling of the PLA powder in a plastisol or organosol state. Plasticizers having a PLA compatible polar segment such as an ester or an ether sequence and a relatively non-polar hydrocarbon sequence are particularly suitable. The plasticizers which impart flexibility include, but not limited to, sorbitol derivatives such as isosorbide diesters, citric acid esters, alkyl phenol ethoxylates and the like. A PLA plastisol or PLA organosol formulation can include from about 10 wt % to about 70 wt % of the plasticizer. Further, an PLA organosol formulation can include from about 5 wt % to about 50 wt % of diluent(s) and/or dispersants.

The step of forming a plastisol 206 involves dispersing the PLA powder in the selected plasticizer. The dispersion can be made in a conventional mixer assembly. Surprisingly, such dispersion of PLA powder in plasticizer forms strong stable thin gloves or films after fusion. In one embodiment, the dispersion of PLA powder in plastisol is made using a high shear blender or a rotor/stator assembly or a homogenizer such as IKA Ultra Turrax T-25 available from IKA Works, Inc. to form a fine dispersion or plastisol. Such mixing of the PLA powder and plasticizer forms a stable plastisol. In some embodiments, a non-ionic surfactant is added in the PLA plastisol. Non-ionic surfactants are preferred over cationic or anionic surfactants to prevent any rapid degradation of PLA during the dip forming process and/or in various conditions under which the PLA gloves are used. Other additives such as defoaming agents, cross-linking agents, chain extenders, aging and hydrolytic stabilizers for PLA can also be added to improve processability, physical properties, biodegradability and to control aging.

In one embodiment, a stable plastisol is prepared by dispersing 20 g of PLA powder in 11.5 g of a biodegradable plasticizer with 13.5 g of non-ionic surfactant. In this embodiment, the PLA powder was Ecorene NW-31 PLA powder available from ICO Polymers; the biodegradable plasticizer was Polysorb ID-37 from Roquette, France, which is a composition of isosorbide diesters produced from fatty acids of vegetable origin and isosorbide obtained by simple modification (dehydration) of a derivative of glucose, sorbitol; and the non-ionic surfactant was Triton X-100, which is Octylphenolpoly(ethyleneglycolether)x from the Dow Chemical Company.

In embodiments of dip forming, a PLA plastisol is formulated to have a viscosity suitable for the dip forming process. The viscosity of the PLA plastisol suitable for the dip forming process can be obtained by varying amount of plasticizer, plasticizer viscosity, particle size of PLA powder, and/or by adding a surface-active agent and/or surface-active coating to the PLA.

Referring back to FIG. 7, a ceramic or aluminum glove former of a desired size is heated to about 60° C. to 75° C. in the step 212 in preparation of dip forming using the PLA plastisol having a suitable viscosity. The pre-warmed glove former is then gently immersed in the PLA plastisol 214 to produce a continuous uniform deposit of the dispersion on the former. The former can be subjected to a rotational and wavy motion to distribute the dispersion evenly on the former.

A PLA layer formed by such dipping step is about 0.03 to 2 millimeters thick. The thickness of the elastomeric layer can be controlled by adjusting various process parameters such as viscosity of the PLA plastisol, duration of the former immersed in the PLA plastisol, rotational speed of the former, etc. The PLA layer can be solidified 216 and the dipping step can be repeated 218 to form a multilayer PLA glove. In some embodiments, each dipping step can be carried out with a different PLA plastisol or PLA organosol formulation to form a multilayer glove including PLA layers having different properties. In some embodiments, one or more layers can be formed using a non-PLA formulation.

The PLA layer(s) formed on the glove former is heated to a temperature between about 125° C. and about 200° C. for several minutes to fuse the PLA 222. The temperature and duration of the fusing step 222 depend on a formulation of the PLA plastisol. For example, a PLA plastisol formulation including a high level of plasticizer and/or containing an amorphous PLA fuses at a lower temperature than a formulation that includes a comparatively lower amount of plasticizer and crystalline PLA. The fusion temperature is normally above a glass transition temperature of the PLA. After the PLA polymer has been fused, the glove can be peeled off from the glove former 224.

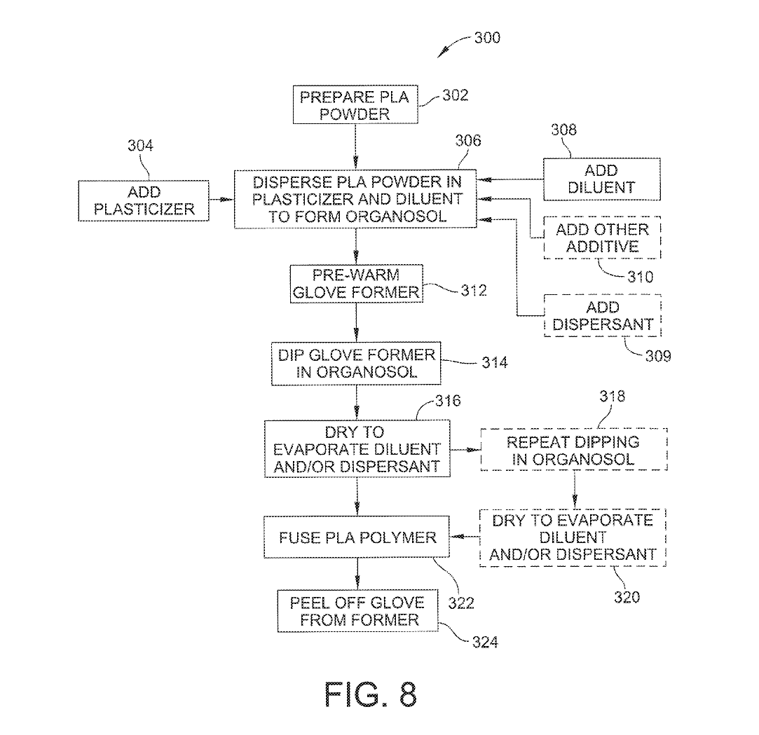

FIG. 8 is a flow chart illustrating a method of dip forming a PLA glove from a PLA organosol according to an embodiment of the present invention. The method 300 is similar to the method of dip forming a PLA glove from a PLA plastisol 200 in that the method includes steps of preparing a PLA powder 302, selecting a plasticizer 304, dispersing the PLA powder in the plasticizer 306, pre-warming a glove former 312, dipping the pre-warmed former in the organosol 314, fusing the PLA polymer 322, and peeling off the PLA glove from the former 324. However, the method further includes a step of adding a diluent 308 to form a PLA organosol instead of a PLA plastisol in the step 306. Optionally, a dispersant can be added 209 to obtain a viscosity of the PLA organosol suitable to dip form a glove having a desired thickness.

Further, the method 300 includes a step of heating the PLA dipped glove former to a moderate temperature to evaporate the diluent and/or dispersant in the step 316 prior to the fusion step 322. This drying step can be performed at a temperature between about 60° C. and about 90° C., for example in a forced air circulating oven. This drying step 316 can be carried out within a few seconds or minutes. As it was with the method 200, the dipping step and the drying step can be repeated 318, 320 to form a multilayer glove.

In some embodiments, other additives such as flavoring agents, detackifying agents, donning enhancing agents, and/or botanical components can be added to the PLA plastisol or PLA organosol in steps 210, 309. Further, one or more therapeutic additives having one or more therapeutic components having one or more qualities of wound healing, anti-inflammatory properties, and anti-microbial properties, and/or other additives such as a colorant can be added.

In one embodiment, the PLA glove formed via the method 200 or 300 includes a PLA between 30 wt. % and 90 wt. %, preferably between 50 wt. % and 80 wt. %, more preferably between 60 wt. % and 75 wt. %; and a biodegradable plasticizer between 10 wt. % and 70 wt. %, preferably between 20 wt. % and 40 wt. %, and more preferably between 25 wt. % and 35 wt. %; has a thickness between about 0.01 mm and about 2 mm, preferably between about 0.03 mm and about 1 mm, and more preferably between about 0.05 mm and about 0.2 mm; a tensile strength (measured according to ASTM D412) of at least 5 MPa, preferably above 10 MPa, more preferably above 15 MPa, and particularly between about 10 MPa-25 MPa; and an elongation at break (ultimate elongation) of at least about 100%, preferably above 200%, more preferably above 400%; and particularly between 250% and 450%. The glove does not show very high modulus at low elongation for better comfort and low fatigue when using the glove. For example, the modulus at 100% elongation should be less than about 10 MPa, preferably less than about 6 MPa, more preferably less than about 4 MPa, and particularly between 1 MPa and 4 MPa.

The following examples illustrate applications and practices according to embodiments of the present invention. These examples are presented by way of illustration and not of limitation.

### Example 1

An organosol formulation is prepared in a laboratory by mixing 60 g of Ecorene NW-31 PLA powder (ICO Polymers), 30 g of Citroflex A4 citric acid ester plasticizer (Vertellus), 3 g of Triton X-100 non-ionic surfactant, and 75 g of Isopropyl alcohol diluent. A thin layer of the organosol was deposited on an aluminum plate; dried at about 85° C., and fused at about 200° C. for 60 seconds to form a smooth, very strong, coherent flexible film.

### Example 2

An organosol was prepared in a laboratory by dispersing 11.6 g of Ecorene NW-61 PLA powder from ICO Polymers, in 5 g of an Isosorbide diester plasticizer (Polysorb ID-37 from Roquette Industries), 0.2 g of Triton X-100 non-ionic surfactant, and 15 g of Isopropyl alcohol diluent. A thin layer of coated dispersion was dried at about 85° C., and fused at about 130° C. for 10 min to form an extensible, smooth, strong, clear and coherent film having a tensile strength of about 11.3 MPa.

### Example 3

An organosol was prepared in a laboratory by dispersing 12.7 go of PLA powder Ecorene NW-31, 12.3 g of Isosorbide diester (Polysorb ID-37) in 15 g of IPA diluent. The dispersion after coating was dried at about 85° C., and fused at about 200° C. for 60 seconds to form a strong, flexible coherent film having a tensile strength of about 11.4 MPa.

### Example 4

A plastisol was prepared in a laboratory by dispersing 20 g Ecorene NW-31 powder, with 11.5 g of Polysorb ID-37 and 13.5 g of Triton X-100. A thin layer of the plastisol was coated, and fused at about 200° C. for 60 seconds to form a clear coherent film.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What is claimed is:

1. A method of forming a thin article, comprising:
dispersing a polylactic acid polymer powder in a plasticizer to form a PLA dispersion; and
forming a thin article using the dispersion.

2. The method of claim 1, further comprising preparing the polylatic acid polymer powder having an average particle size below about 100 micron.

3. The method of claim 1, wherein the step of dispersing includes selecting the plasticizer compatible with the polylactic acid polymer, mixing the plasticizer and the polylactic acid polymer powder to form a PLA plastisol, and controlling a viscosity of the PLA plastisol for the dip forming process.

4. The method of claim 3, wherein the PLA plastisol is formed by mixing the polylactic acid polymer powder between about 50 wt. % and 80 wt. %, and the plasticizer component comprises between about 20 wt. % and 40 wt. %.

5. The method of claim 3, wherein the PLA plastisol further includes a non-ionic surfactant.

6. The method of claim 3, wherein controlling of the viscosity for dip forming process comprises adding a diluent, thereby forming a PLA organosol.

7. The method of claim 6, wherein the controlling of the viscosity further includes adding a dispersant.

8. The method of claim 1, wherein the step of forming includes dip forming a glove from the PLA dispersion, wherein a glove former is dipped in the PLA dispersion and heated to fuse the polylactic acid polymer to form a glove including at least one polylactic acid polymer elastomeric layer.

9. The method of claim 1, wherein the polylactic acid polymer component comprises D-polylactic acid, L-polylactic acid, D,L-polylactic acid, meso-polylactic acid, and any combination of D-polylactic acid, L-polylactic acid, D,L-polylactic acid, and meso-polylactic acid.

10. The method of claim 1, wherein the plasticizer comprises a biodegradable plasticizer component selected from a group consisting of polyethylene glycol, polypropylene glycol, a sorbitol derivative, a glucose monoester, a citric acid ester, an epoxidised oil, a lactide monomer, and an octyl phenol ethoxylate.

11. The method of claim 1, wherein the dispersion further comprises at least one of a flavoring component, an antimicrobial agent, a detackifying agent, a botanical extract, a donning enhancing agent, a colorant component, and a therapeutic component incorporated into one or more of the at least one elastomeric layer.

12. A polylactic acid polymer dispersion for forming a thin article, comprising:
a polylactic acid polymer powder dispersed in a plasticizer; and
wherein the plasticizer is compatible with the polylactic acid polymer.

13. The dispersion of claim 9, wherein the dispersion is a plastisol having a viscosity suitable for a dip forming process, wherein the plastisol includes the polylactic acid polymer powder between about 50 wt. % and 80 wt. %, and the plasticizer between about 20 wt. % and 40 wt. %.

14. The dispersion of claim 12, further including a non-ionic surfactant.

15. The dispersion of claim 12, wherein the plasticizer is a biodegradable plasticizer, wherein the biodegradable plasticizer is selected from a group consisting of polyethylene glycol, polypropylene glycol, sorbitol derivatives such as isosorbide diesters, glucose monoesters, citric acid esters, epoxidised oils, lactide monomers, octyl phenol ethoxylates.

16. The dispersion of claim 12, further including a dispersant; wherein the dispersion is a organosol having a viscosity suitable for a dip forming process.

17. The dispersion of claim 12, wherein the thin article is an elastomeric glove.
